(19) United States
(12) Patent Application Publication
(10) Pub. No.: US 2013/0259347 A1
(43) Pub. Date: Oct. 3, 2013

(54) COMPUTER TOMOGRAPHY SYSTEM AND METHOD FOR DATA DETERMINATION FOR AN INTERFERENCE-CORRECTED CT RECORDING OF A TEST OBJECT

(71) Applicant: Fraunhofer-Gesellschaft zur Foerderung der angewandten Forschung e.V., (US)

(72) Inventors: Michael SCHMITT, Grossenseebach (DE); Stefan REISINGER, Fuerth (DE); Virginia VOLAND, Fuerth (DE); Michael SALAMON, Fuerth (DE); Michael KRUMM, Ueberlingen (DE)

(73) Assignee: Fraunhofer-Gesellschaft zur Foerderung der angewandten Forschung e.V., Munich (DE)

(21) Appl. No.: 13/852,318

(22) Filed: Mar. 28, 2013

(30) Foreign Application Priority Data
Mar. 30, 2012 (DE) 102012205225.9

(51) Int. Cl. G06T 11/00

(52) U.S. Cl. CPC G06T 11/005
USPC 382/131

(57) ABSTRACT

A method for data determination for a computer tomography recording of a test object includes detecting a sequence of different subsets of measurement transmission recordings of the test object at predetermined, different measurement angle positions, to acquire an overall number of measurement transmission recordings based on the different subsets of measurement transmission recordings; and a repeated detection of a reference transmission recording of the test object at different reference times at a reference angle position, wherein one reference time each of the different reference times is temporally between two detection processes for the different subsets of measurement transmission recordings.

### CROSS-REFERENCE TO RELATED APPLICATIONS

This application claims priority from German Patent Application No. 102012205225.9, which was filed on Mar. 30, 2012, and is incorporated herein in its entirety by reference.

### BACKGROUND OF THE INVENTION

The present invention relates to a computer tomography system and a method for data determination for a computer tomography recording of a test object or test body. In particular, the present invention relates to a device and a method for an operation-synchronized detection and compensation of time-dependent interferences at computer tomography systems.

Computer tomography (CT) is widely used in the field of medicine and for example non-destructive materials testing. In computer tomography, the interaction between the generated x-radiation and the matter or material of the test object is detected.

With conventional computer tomography systems, from an x-ray tube as a radiation source, x-rays in the form of a fan beam or a cone beam are emitted originating from a focal spot (focus) of the x-ray tube, pass through the test object and impinge upon an x-ray detector, e.g. a flat screen detector. According to the CT principle (CT=computer tomography) x-radiation impinges upon matter, wherein depending on the characteristics of the material and the object, e.g. material density and x-ray lengths, a different proportion of the radiation is absorbed by the test object. One single transmission image now results from the detection and visualization of non-absorbed x-radiation. Due to the overlaying of areas of different densities, such as projection contains no depth information with respect to the test object, however. Spatial information regarding the test object may only be determined by a transmission or projection through the area of the test object using further angular positions. The more projections are recorded under different angles, the more depth information (3D information) is available which may then be “reconstructed” from the recordings.

Using the information of the resulting transmission dataset (projection dataset) from a plurality of transmission recordings, now for example using a mathematical transformation an attenuation or weakening value is allocated to one volume element (voxel) of the test object each. The resolution of the reconstructed volume, i.e. the 2D or 3D illustration of the test object, here significantly depends on the number of transmission recordings of the test object executed in different angle positions and on the respective size of the sensor elements of the x-ray detector.

For a reconstruction of layer information of the test object or test body which is as artifact-free as possible, in digital 2D or 3D computer tomography now a knowledge which is as exact as possible of the recording geometry of the radiation emitting arrangements with respect to the test object and the x-ray detector is needed. The attainable spatial resolution, i.e. the 2D/3D reproduction accuracy and the resulting image sharpness now depend on the geometrical characteristics of the imaging system consisting of the x-ray tube and the x-ray detector as well as on the adjustment of the components with respect to each other and to the manipulation unit of the object to be tested. In fan beam or cone beam geometry of a CT system it is now in particular needed for a reconstruction of image information which is as artifact-free as possible that the exact position of the x-ray source, i.e. the focal spot of the x-ray tube (focus) is known in all three spatial directions.

Depending on the size of the focal spot or focus different designations are used for the focal spot. In this respect, reference is made to the following table 1.

TABLE 1
Focus designation according to focal spot size. For the
acceleration voltages typical reference values are indicated.
[Source: Gevatter, Grunhaupt, Springer, 2006]

| Designation | Acceleration Voltage/kV | Focus Size/μm |
|---|---|---|
| Standard Focus | 450 | 500-800 |
| Mini Focus | 250-350 | 100-300 |
| Micro Focus | up to 230 | 5-20 |
| Nano Focus | 50-90 | 1-8 |

For a sufficient image quality it is assumed now that the position of the focal spot is known with an accuracy of ±0.1*v_{eff}. The effective voxel size v_{eff} (with respect to a voxel edge) in the image here depends on the geometrical voxel size and the spatial resolution of the imaging system which in turn are influenced depending on the magnification of the image by the expansion of the radiation source and by the diffraction characteristics of the x-ray detector. Thus, for a computer tomography recording which is as interference-free as possible it is to be assumed that the focal spot position ought to be known in particular with an accuracy clearly below the focal spot size.

In case of high resolution CT measurements for which small focal spot sizes (micro focus or nano focus, see table 1) are used, it is not given, however, that focal spot position is known with an accuracy clearly below the focal spot size. Due to thermal influences and due to a possible tube-internal focusing, the focal spot position changes over time. Temperature changes of the x-ray source during data detection (data acquisition) may additionally lead to a change of the magnification in the imaging due to a shifting of the focal spot position in imaging direction, and thus to inconsistent transmission recordings or projection data. The stability of the focal spot position may promoted by an extensive warm up of the x-ray tube. Experiences show, however, that a sufficient stability of the position of the focal spot for the duration of a complete measurement may not be sufficiently guaranteed by in general several hundred transmission recordings (projections).

If a constant focal spot position is assumed despite local fluctuations of the focal spot, in the reconstruction of the data so-called movement artifacts result. These artifacts reduce the resolution or detail recognizability of the measurement in the resulting 2D or 3D CT image. Due to smearing in the image, structure sizes below the geometry change caused by the movement of the focal spot may not be resolved anymore. This leads to an inaccurate analysis and measurement result. Assuming a constant focal spot position, thus reconstruction data of sufficient image quality may only be generated if the position of the focal spot during data acquisition moves within the above-defined tolerance limit which is clearly below the needed resolution. As this tolerance limit is very low in case of high resolution measurements, further measures are needed to determine the focal spot position or its possible movement during data acquisition and to consider this determined movement in the reconstruction of the transmission datasets (projection datasets) for error compensation. Such an operation for detection and compensating focal spot movement ought to generate an improved image quality if possible with a relatively small additional effort. In this respect it is further needed that relatively precise values of the focal spot position are determined for the compensation of the focal spot movement.

### SUMMARY

According to an embodiment, a method for data determination for a computer tomography recording of a test object may have the steps of detecting a sequence of different subsets of measurement transmission recordings of the test object at predetermined, different measurement angle positions to acquire an overall number of measurement transmission recordings based on the different subsets of measurement transmission recordings; and repeatedly detecting a reference transmission recording of the test object at different reference times at a reference angle position, wherein one reference time each of the different reference times is temporally between two detection processes for the different subsets of measurement transmission recordings.

According to another embodiment, a computer program product may have a program code for executing the method steps of a method for data determination for a computer tomography recording of a test object which may have the steps of detecting a sequence of different subsets of measurement transmission recordings of the test object at predetermined, different measurement angle positions to acquire an overall number of measurement transmission recordings based on the different subsets of measurement transmission recordings; and repeatedly detecting a reference transmission recording of the test object at different reference times at a reference angle position, wherein one reference time each of the different reference times is temporally between two detection processes for the different subsets of measurement transmission recordings.

According to another embodiment, a computer tomography system for data determination for a computer tomography recording of a test object may have a computer tomography arrangement for generating transmission recordings of a test object, wherein the computer tomography arrangement and the test object are arranged rotatably relative to each other; and a processing and control means or device for processing and controlling which is coupled to the computer tomography arrangement and which is further implemented to detect a sequence of different subsets of measurement transmission recordings of the test object at predetermined angle positions in order to acquire, based on the different subsets of measurement transmission recordings, an overall number of measurement transmission recordings to repeatedly detect a reference transmission recording of the test object at different reference times at a reference angle position, wherein one of the different reference times each is temporally between two detection operations for the different subsets of measurement transmission recordings.

According to another embodiment, a processing and control means for a computer tomography system may execute the method for data determination for a computer tomography recording of a test object which may have the steps of detecting a sequence of different subsets of measurement transmission recordings of the test object at predetermined, different measurement angle positions to acquire an overall number of measurement transmission recordings based on the different subsets of measurement transmission recordings; and repeatedly detecting a reference transmission recording of the test object at different reference times at a reference angle position, wherein one reference time each of the different reference times is temporally between two detection processes for the different subsets of measurement transmission recordings.

It is the basic idea of the present invention that the determination of interferences is integrated in the measurement course by the acquisition of the same transmission data (projection data) several times in the form of reference transmission recordings (reference projections). During the acquisition of the transmission dataset (projection dataset) of the test object, one or several predefined reference positions are approached by the axis of rotation and, if applicable, further axes around which the test object is moveable or rotatable with respect to the CT system, in order to detect transmission recordings (projections) of the test object there which may be used as a reference for determining interferences. Without a geometrical change of the image or other interferences thus reference transmission recording result which are identical except for image noise. By corresponding processing methods, e.g. using a cross-correlation or the least-squares method or also other possible image processing methods, changes in the image geometry between the x-ray tube, the test object and/or the x-ray detector or also other interferences are detected. The currently recorded reference transmission recording is thus referenced to the last recorded, the first recorded or any other reference transmission recording at the same axial position (angular reference position).

Resulting image changes exceeding image noise and which are the result of changes in image geometry due to other interferences, may thus be detected “time-dependently”, as different reference information exists with respect to the respective interference or its temporal course at different times. Depending on the selected interval of reference times for detecting one or several reference transmission recordings or on the number of recorded reference transmission recordings which may, for example, also be used as so-called supporting points for an interpolation for determining a correction function, a high temporal sampling and in combination with it the detection of temporally high-frequency interferences may be acquired.

Embodiments of the present invention describe a method for the detection and compensation of focal spot movements based on the image data of the test object without the use of reference objects. The acquired information on focal spot movement is used as information on image geometry for the reconstruction of image data without executing mechanical movements or applying image processing operators with respect to the projection data. Thus, the examinable object area and further the acquired spatial resolution may be maximized, wherein according to embodiments of the present invention a method and a device for compensating focal spot migrations are used which get by without the use of reference objects and without a mechanical movement of the x-ray components.

The present operation for data acquisition for a computer tomography recording of a test object in a CT system which is as interference-reduced as possible will show the following sequence for example in case of a CT measurement having k angular steps (k≧ e.g. 360, 720, 800, 1600 or any number of intermediate values). First of all, one or several significant reference positions are determined or defined. Such angular reference positions enable, based on the reference transmission recordings, to acquire significant reference information at these angular reference positions which may provide determinable information with respect to the interference on measurement transmission recordings. Here, for example, angular reference positions are selected which enable reference transmission recordings clearly illustrating emphasized clear exterior structures, a high image contrast, a favorable aspect ratio, e.g. for transmission lengths as short as possible and/or internal structures or structurings. Thus, different reference transmission recordings may be compared or referenced “in a relatively simple way” by means of image processing methods, like e.g. cross-correlation calculations or least-squares calculations based on the reference transmission recordings.

Thereupon, data recording is initiated in the form of the detection of measurement transmission recordings of the test object. For example, data recording (i.e. the first measurement transmission recording) may be started at an angular measurement position which corresponds to an angular reference position.

In the determination of the first subset of measurement transmission recordings at m measurement angle positions (with m<k), thus m measurement transmission recordings of the test object are detected. If data acquisition was started in a reference position, the first measurement transmission recording may additionally also be used as a reference transmission recording.

Thereupon, a reference transmission recording of the test object is executed at the further reference angle position, wherein for example by an image processing operation or image comparison with a preceding reference transmission recording, information on interferences may be derived using these reference transmission recordings between the two reference times at which the different reference transmission recordings where determined. If no interferences may be found, the reference transmission recordings only differ by a noise portion in the image at the same angle positions. Further, now additional information on interferences may be derived for example for all measurement transmission recordings recorded in time between the reference transmission recordings, e.g. by an interpolation. As interference information of corresponding correction information exists, the reconstruction of the measurement transmission recordings may now be started directly.

The above-presented proceedings for acquiring or detecting a sequence of different subsets of measurement transmission recordings of the test object at given measurement angle positions and the repeated detection of a reference transmission recording of the test object at different reference times temporally between two detection processes for the different subsets of measurement transmission recordings is now repeated until the complete transmission dataset with all needed or provided measurement transmission recordings, i.e. the complete number k of measurement transmission recordings, has been acquired. It is to be noted with respect to the inventive proceedings, that the number m of measurement transmission recordings to be recorded between two reference transmission recordings and thus the sampling frequency of the reference transmission recordings does not have to be constant over the measurement duration. For example, the number m (number of measurement transmission recordings per subset) may be increased with an increasing measurement duration or be adapted dynamically with respect to the runtime using the results of the comparisons of preceding reference transmission recordings. In this context it is further to be noted, that the recording of a further subset of measurement transmission recordings of the test object may already be started before the derivation process of information on interferences of the preceding subsets has been completed.

The number of detection processes for reference transmission recordings indicates a measure for the temporal sampling of interferences or a change of image geometry. The order of detection or determination of the actual measurement transmission recordings may basically be executed randomly. Thus, for example, the recording of the measurement transmission recordings in case of n supporting points (i.e. reference information based on the reference transmission recordings) may be divided into n-1 equal parts, so that the temporal sampling of the supporting points takes place distributed as evenly as possible across the dataset (transmission dataset or projection dataset) or the measurement time. A supporting point (reference information) is now based on one or on a plurality of reference transmission recordings at a reference time. In the method for data acquisition for a computer tomography recording of a test object in a CT system which is as interference-reduced as possible, thus the test object itself represents the reference object or the reference structure.

From the image sequence of the reference transmission recordings the relative positions of the image geometry and in particular the optical focal spot of the x-ray device may be determined at discrete times. These time-discrete points in time represent the supporting points for the determination of a function which is continuous with respect to place and time, which approximately describes the relative position of the optical focal spot at any time of the measurement time period. Thus, using this function, the relative position of the optical focal spot may derived for any projection on the basis of an interpolation. The quality of the derivation may here be improved by a (finite) increase of the temporal sampling frequency of the reference projections. This interference function or correction function which describes the relative focal spot position at any point in time in the measurement time period may now be made available for the reconstruction algorithm as project-related additional information. Thus, the low-pass character of a moving focal spot may be compensated in the subsequent reconstruction of a 2D or 3D CT recording. This leads to an increased resolution or detail recognition of the measurement system.

The inventive proceeding distinguishes itself thus by the fact that the same may be used as a basis for the detection and compensation of time-dependent interferences or geometrical image changes. Geometrical and other influential factors may be detected and quantified reliably using this method.

The inventive concept thus enables a high precision of the compensation of focal spot movement. Apart from angle dependency of the determinability of the focal spot position, also the temporal component is considered, so that depending on the sampling rate also a high-frequency or quickly changing focal spot movement may be detected and compensated. This directly leads to a reduced blur and thus to an improved image quality in the reconstruction data. On the basis of the improved image data, more precise and robust analysis and measurement results according to the respective examination task may be acquired. This improvement of image quality may in particular also be acquired without the use of reference bodies. Thus, the maximum image size may be used for imaging the test object, which is why a maximum spatial resolution and detailed recognition may be realized.

Apart from the detection and compensation of focal spot movement, using the present proceedings also a change of magnification in the image may be detected and compensated as well as, under boundary conditions, a movement of the object.

In the following, now using documents of standard technology, problems of conventional CT recording systems are discussed, wherein further the findings and inventive conclusions of the inventors are highlighted considering the object underlying the present invention.

Some processes for the temporal determination and correction of the change of system geometry of a CT system using image data were tested based on the scientific publication of “A. Sasov, S. Liu, P. Salmon, Proc. Of SPIE, 7078, 70781C-1, 2008” (SEM=Scanning Electron Microscope).

An iterative method described therein by means of forward and backward projection uses a first of all uncorrected, potentially artifact-afflicted reconstruction volume to generate a transmission dataset (projection dataset) to be expected using the same by means of the radiation sum method. This dataset is compared to the recorded transmission dataset projection-wise. For each transmission recording, using the least-squares method or using a cross-correlation, an estimated focal spot projection is determined. A renewed reconstruction of the complete transmission dataset is then executed considering these estimates. As it is now assumed that the estimates of the first step may be further improved by further iterations and the error measure and thus the artifacts in the image may be further reduced, this method is repeated until a threshold value for error tolerance is fallen short of. The last generated reconstructed volume then corresponds to the final corrected volume.

With a so-called fast pre- or post-scan process directly before or after the measurement of the complete transmission dataset a further faster scan of the object is executed. An angular step size of 30° or 45° is for example proposed, which corresponds to a dataset of 12 or 8 transmission recordings (projection images) with a full scan of 360°. The recording of such a reference dataset at the SEM ought to be completed within two minutes. If now conventional CT systems with x-ray tubes are used as a radiation source, a reduction of the needed measurement time for the reference dataset may be expected, as a clearly higher photon flux may generally be generated using x-ray tubes. For those eight or twelve reference positions now again using the least-squares method or using a cross-correlation, considering the actually measured data, values for the focal spot position are determined. These values are determined relative to the position of the focal spot where the same was located before or after the measurement, depending on whether the fast scan was executed before or after the measurement.

The two above-mentioned methods are based on the comparison of the recorded transmission recordings to reference transmission recordings using which a correction value for balancing the focal spot movement is determined. In case of the iterative method this is separately possible for every transmission recording. For every transmission recording, thus a correction value may be determined which is independent of the remaining dataset. It is essential for this method, however, that a complete reconstruction of the dataset including all movement artifacts is present before the determination of the correction values may start. The determination of the correction value may thus start no earlier than with the recording of the last transmission recording of the dataset. As this is an iterative method it additionally depends on the convergence behavior how fast the determination of the parameters is completed and the final artifact-reduced reconstruction is provided.

In case of such a fast scan before or after the measurement, i.e. after the determination of the complete transmission dataset with all transmission recordings, additional measurement data is generated with respect to the transmission dataset relevant for the reconstruction of the test object. This approach follows the assumption that the position of the focal spot does not change during the fast scan, for which typical measurement times of approximately two minutes are given. Also with clearly shorter measurement times tests have shown that this assumption is generally not true. A potential focal spot migration during the recording of the fast scan is included into the complete transmission dataset (projection dataset) of the test object in this method and possibly deteriorates the same. Apart from that this method introduces an error potential in so far as the comparison of the projections provides results of a different precision from different angles depending on the nature of the object. It is thus not likely that for all 8 or 12 supporting points the focal spot position may be determined with the same precision.

It was now found with respect to the present invention that it is more precise to select an angular position in which an image registration or other image processing methods/processes for determining the focal spot position are possible for which reliably reproducible results with a small error are to be expected and to then use these angular positions as reference positions. This approach is used in embodiments of the present invention to acquire object-dependent reference positions for expressive reference transmission recordings of the test object. This is not found in standard technology.

It is further noted with respect to the scientific publication “A. Sasov, S. Liu, P. Salmon, Proc. Of SPIE, 7078, 70781C-1, 2008”, that as a special case of the so-called post-scan it may frequently be observed that after the actual measurement only the first transmission recording is recorded again and compared to the first transmission recording from the dataset. A detected focal spot movement between the two reference projections is assumed to be linear and all further projections are corrected by means of linear interpolation. This method may already result in an improvement in comparison to an uncorrected reconstruction of the data with high spatial resolutions, the assumption of a linear focal spot movement will generally not correspond to the actual movement, however. In particular high-frequency focal spot movements are not detected by the simplified assumption and remain unconsidered. Thus, this method for detection for balancing or compensating the focal spot movement neither acquires a strongly increased precision of the determined focal spot positions nor an improved allocation to the measured projections, wherein in particular a relatively high additional effort is needed as the reconstruction may only be started after a complete data recording.

WO 2008/141825 A3 relates to a method, a device and an arrangement for recording x-ray projection images, wherein using an x-ray tube and a x-ray sensitive detector several projections of a test object are recorded in time one after the other using different angular positions, and wherein a reference object is imaged onto the detector, from the position of the reference object in the images of the projections the migration of the former focal spot position is calculated and for the second and subsequent projection this migration is each compensated before the respective temporally subsequent projection is recorded.

According to WO 2008/141825 A3 an immediate compensation of the focal spot movement in the projections is executed by methods of image processing and additionally by an actual mechanical movement of the radiation source or alternatively of the test object and the x-ray detector. The compensation of the focal spot movement by changing the imaging geometry, e.g. by a movement of the radiation source, the test object and/or the detector is according to definition connected to a temporal latency and is estimated not to be sufficiently precise for high-resolution imaging methods. The focal spot movement is thus detected with the help of spatially unchanged or stationary reference objects, e.g. steel balls, apertures, which in this case, according to definition, are not the test object as the same does not remain stationary. Using this method, a prompt compensation of the focal spot movement in the projections is possible, wherein, however, by the additional imaging of stationary reference objects a part of the active surface of the x-ray detector is shadowed by objects which are not part of the object to be examined and thus do not carry information which is relevant for the test or measurement task. The testable object area is thus limited.

### BRIEF DESCRIPTION OF THE DRAWINGS

In the following, embodiments of the present invention are explained in more detail with reference to the accompanying drawings, in which:

FIG. 1 shows a schematic diagram of an inventive CT system according to an embodiment of the invention;

FIG. 2 shows a flowchart of a method for data determination for a computer tomography recording of a test object according to an embodiment of the present invention; and

FIG. 3 shows a further flowchart of a method for data determination for a computer tomography recording of a test object according to a further embodiment of the present invention.

### DETAILED DESCRIPTION OF THE INVENTION

Before embodiments of the present invention are explained in more detail in the following with reference to the drawings, it is noted that identical, functionally identical or seemingly identical elements, objects and/or structures in the different figures are provided with the same reference numerals, so that the description of those elements presented in the different embodiments is interchangeable or maybe mutually applied.

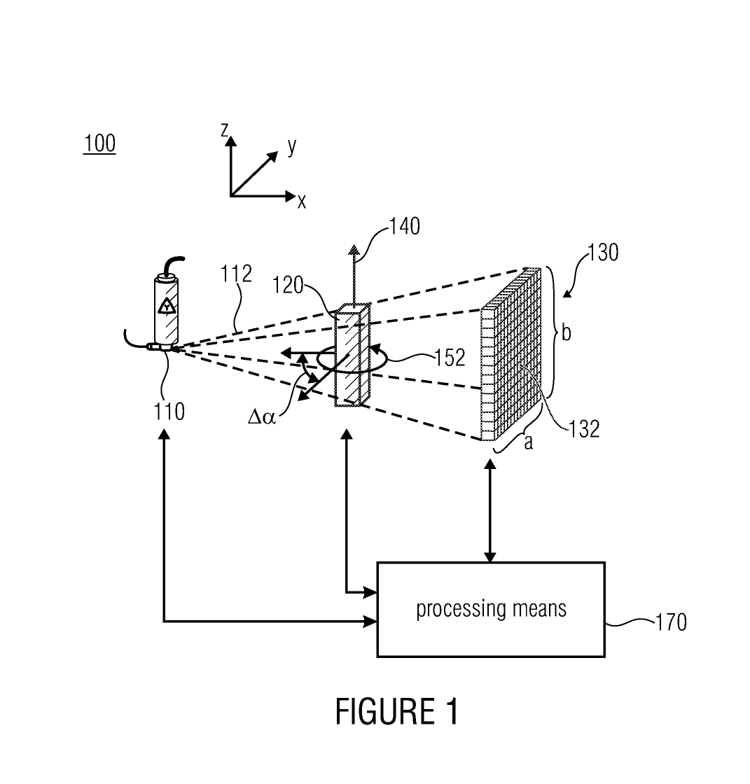

FIG. 1 shows an illustration of a CT system 100 according to one embodiment of the present invention for data determination for a computer tomography recording of a test object 120 (test body) (which is as interference-free or interference-reduced as possible). The CT system 100 for example comprises an x-ray tube 110 and a (planar) detector 130 sensitive for x-radiation 112 in the form of a flat screen detector or planar x-ray detector. The x-radiation 112 emitted by the x-ray source 110 penetrates or passes through the test object 120 and impinges upon the detector 130 which is sensitive for x-rays.

After the transmission or passage of the x-rays 112 the test object 120 one single measurement transmission recording results. The measurement transmission recording contains image information on line integrals on attenuation coefficients in the transmission of the x-rays 112 through the test object 120.

Further, a processing and control means 170 is allocated to the CT system 100 which serves for controlling the CT system 100 including the x-ray source 110 and the x-ray sensitive detector 130, for controlling the movements of the test object 120 and further for the evaluation of the detected transmission images (measurement and also reference transmission images). In FIG. 1, the x-ray transmission recording comprises a projection of the three-dimensional volume of the test object 120, wherein the transmission recording or projection is generated by the fact that the x-rays 112 emitted by the x-ray source 110, after passing through the test body 120 are imaged onto the two-dimensional surface 132 of the x-ray sensitive detector 130. The x-ray sensitive detector 130 is for example implemented as a solid state detector and may be implemented as a line detector, e.g. with a fan beam CT, or as a multiline or area detector, e.g. with a 3D cone beam CT.

In the exemplary arrangement illustrated in FIG. 1, the CT system 100 comprises a 3D cone beam CT, wherein the x-ray source 110 in the focus or focal spot may be regarded as being approximately point-shaped, and wherein the x-ray sensitive detector 130 is implemented as a multiline detector with a two-dimensional surface of for example a×b pixels. In data determination, for example for a 3D image of the test object 120 using computer tomography, the test object 120 is rotated for example with a uniform angular step width Δα around an axis of rotation 140, while in the rotation of the test body 120 an angular range 152 (for example a complete angular range of 360° in a rotational plane perpendicular to the axis of rotation 140 is exceeded to acquire a sequence of transmission recordings at the associated angular positions.

In industrial CT, for example, the projection dataset which serves as a basis for the reconstruction of depth information of the test object 120 is conventionally acquired within a complete revolution or rotation of the test object 120 or the x-ray components in case of a Gantry system around its axis of rotation in small angular steps. Here, the CT system consisting of x-ray source 110 and x-ray sensitive detector 130 is arranged rotatably relative to the test object 120. Depending on the angle number, the full circle is for example divided into equidistant angle positions Δα which are sequentially approached.

Alternatively, the recording of transmission recordings may also be executed by rotating the test object 120 around any other axis of rotation except for the axis of rotation in parallel to the x axis (for example around an axis of rotation in parallel to the y axis in the x, z plane), in order to acquire a complete set of measurement transmission recordings. Each transmission recording comprises the image information in the form of a 2D matrix of transmission values typically present as intensity values. By means of a computer-based evaluation which may for example be executed on the basis of a mathematical transformation (e.g. radon transformation), from a plurality of the measurement transmission recordings (from the transmission dataset or projection dataset) a 3D image or 3D volume is reconstructed, wherein to each volume element or voxel of the 3D image an attenuation coefficient or absorption degree is allocated.

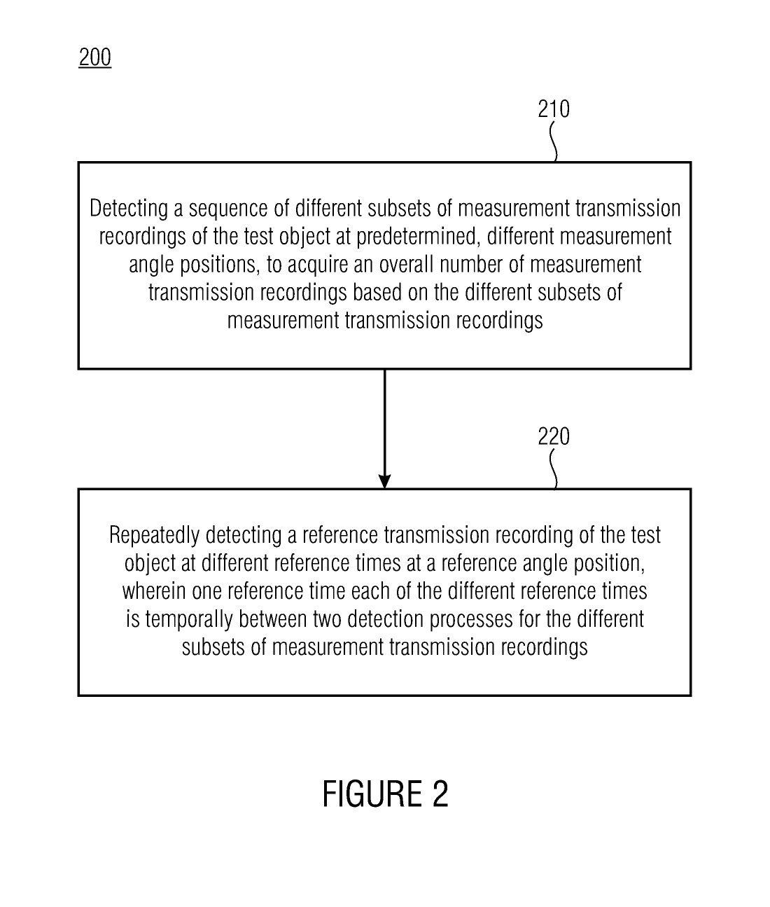

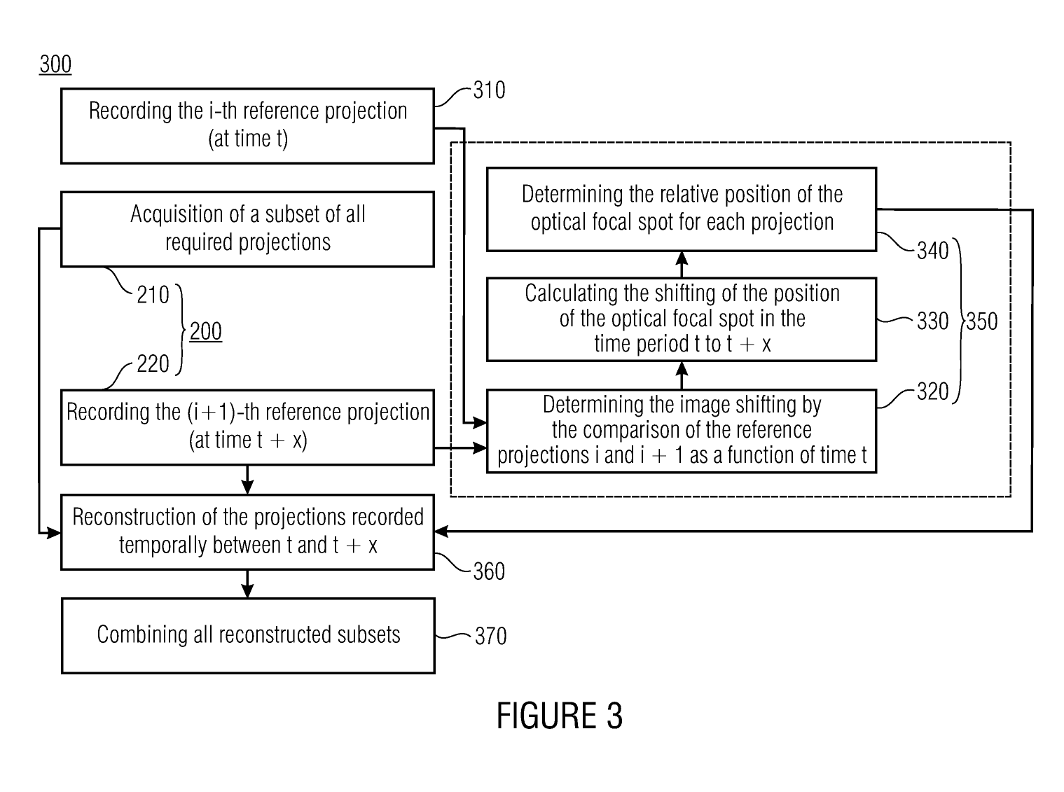

In the following, using the components of the CT system 100 illustrated in FIG. 1 and using the method steps illustrated in FIGS. 2 and 3, the inventive concept, i.e. the functioning of the components of the CT system 100 and the course of the method are described for an operation-synchronized detection and compensation of time-dependent interferences with respect to measurement transmission recordings at computer tomography systems.

In particular, the functioning of the processing and control means 170 and further the associated method procedure for data determination for a computer tomography recording of the test object or test body 120 in a CT arrangement using the x-ray source 110 and the x-ray detector 130 are explained. Here, the CT arrangement and the test object 120 are arranged rotatably with respect to each other. When it is indicated in the following description that different angular positions of the test object 120 with respect to the x-ray source 110 and the detector (or a transmission plane formed by the same) are to be set, it ought to be obvious that in this respect for example suitable actuating means (actuators) may be used to exactly acquire the desired angular positions (measurement and/or reference angular positions) for the respective transmission recordings. These control means are controlled by the processing and control means 170, wherein in a subsequent description it is indicated for simplification that the processing and control means 170 set the respective angular positions.

Apart from that it is noted that it is indicated in the following description that different transmission recordings (e.g. measurement and/or reference transmission recordings) are detected. This detection is executed in cooperation with the x-ray detector 130 which then transfers corresponding detection data to the processing and control means 170. The detection data here contains the image data of the respective transmission recordings which may then for example be rendered and further processed in the processing and control means 170. The double arrows illustrated in FIG. 1 originating from the processing and control means 170 ought to indicate that also a bidirectional data communication is possible between the different elements each.

In industrial computer tomography, a transmission dataset (projection dataset) which serves as a basis for the reconstruction of depth information of the test object 120 is conventionally detected within a complete revolution (360°) of the object or the x-ray components in case of a Gantry system around its axis of rotation in small angular steps, e.g. Δα≦1°. Depending on the angle number, the full circle is separated into equidistant angle positions Δα which are approached one after the other.

According to embodiments of the present invention, the processing and control means 170 is coupled to the computer tomography arrangement 110, 130 and its further implemented to detect a sequence of different subsets of measurement transmission recordings of the test object 120 at predetermined angle positions to acquire an overall number of measurement transmission recordings based on the different subsets of measurement transmission recordings and to repeatedly detect a reference transmission recording of the test object at different reference times at a reference angle position, wherein one of the different reference times each is located temporally between two detection processes for the different subsets of measurement transmission recordings.

According to embodiments of the present invention, the method 200 for data acquisition for a (interference-reduced) computer tomography recording of a test object 120 in the CT system 100 now consists of first detecting a sequence of different subsets of measurement transmission recordings of the test object 120 at given different measurement angle positions Δα to acquire the complete number of measurement transmission recordings based on a combination of the different subsets of measurement transmission recordings. Further, a reference transmission recording of the test object 120 is detected repeatedly at different reference times t+ix (with i=0, 1, 2, 3 . . . n) at at least one reference angle position 13 (step 220 of FIG. 2), wherein one reference time each of the different reference times is located temporally in between two detection processes for the different subsets of the measurement transmission recordings.

The reference transmission recordings for determining the image shifts resulting from the focal spot movement are, according to embodiments, generated by approaching the same recording geometry several times, i.e. at different reference times the same recording geometry is each generated with one or several reference transmission recordings. It may also be needed here to move several axes (e.g. the axis of rotation 140 and if applicable further axis of the test object 120) to approach the reference positions.

Thus, the reference transmission recordings which serve for evaluating a possible interference on the measurement transmission recordings are each determined in between the detection of different subsets of the measurement transmission recordings.

This way, interferences may be integrated into the actual measurement process for detecting the measurement transmission recordings by detecting or acquiring the same transmission data (projection data) in the form of reference transmission recordings (reference projections) several times. During the detection of the transmission dataset of the test object 120 thus one or several predefined reference angle positions are approached by the axis of rotation 140 and, if applicable, further axes of the test object 120 in order to detect transmission recordings of the test object 120 there which are used as a reference (reference information) for determining interferences on the detection of the measurement transmission recordings.

In step 220 of detecting a reference transmission recording at a reference time, a plurality of reference transmission recordings each of the test object 120 may be detected at different predetermined reference angle positions βₙ, (e.g. of the axis of rotation 140 and if applicable further axes of the test object 120) in order to determine the reference information for an interference-reduction at the measurement transmission recordings based on a plurality of reference transmission recordings.

According to embodiments, the sequence of different subsets of measurement transmission recordings may for example be recorded in different ways. Thus, for example, first of all for detecting for the different subsets of the measurement transmission recordings a (relatively) large step width of >1° is assumed (e.g. an integer multiple of 1°, e.g. 10°, 15°, etc.), in order to acquire a complete rotation for detecting a first subset of measurement transmission recordings at the predetermined measurement angle positions. A complete rotation is for example a resulting overall rotation from 0 to 360° or two opposite partial rotations with 0°±180° from an origin of 0°. It is likewise possible to execute only a partial rotation for determining a subset of measurement transmission recordings. A partial rotation may here be executed from an origin or starting point of 0° up to an integer divisor value, i.e. 360°/b. The value of b here indicates the number of subsets.

After determining a first subset of measurement transmission recordings, now a reference transmission recording is generated at the reference angle position at a first reference time. The reference transmission recording may now be executed at the first reference angle position. Likewise, several reference transmission recordings may be detected at different, predetermined reference angle positions in order to determine the reference information.

As a reference time, i.e. the time of the respective reference recording, when determining one single reference transmission recording per reference time, for example the time of detecting exactly this reference transmission recording is assumed. When detecting a plurality of reference transmission recordings at different, predetermined reference angle positions (per reference time or reference interval), now the reference time is for example the time of the first reference transmission recording (of the plurality of transmission recordings), the time of the last reference transmission recording (of the plurality of transmission recordings) or a predefined intermediate time, e.g. in the middle in between the first reference transmission recording and the last reference transmission recording (of the plurality of transmission recordings). Also any other defined point in time during the time interval may be selected or defined as a reference point for recording the reference transmission recordings, which is associated with one of the reference transmission recordings of a set of reference transmission recordings.

After completing the detection of one or several reference transmission recordings now a further complete rotation or partial rotation is executed for detecting a further subset of measurement transmission recordings at further different measurement angle positions. The further different measurement angle positions may now be offset to the first complete or partial rotation by a predetermined angular value or may comprise a different angle step width with respect to the first or preceding measurement angle positions in order to acquire the further subset of measurement transmission recordings. The respective measurement angle positions may be set with respect to optimizing the amount of data to be processed to acquire as little redundant measurement transmission recordings or transmission data as possible. After completing the detection of a further subset of measurement transmission recordings, now again at the next reference time one or a plurality of reference transmission recordings is executed at the reference angle position or at the several reference angle positions (according to the above method).

According to embodiments of the present invention, thus first of all a first subset of measurement transmission recordings is detected across a partial or complete measurement rotation with a next angle step width, wherein the first angle step width is between 5° and 30° (or between 10° and 20°. Subsequently, a reference transmission recording of the test object is executed at a reference angle position at a first reference time. It is for example also possible to execute the first reference transmission recording before detecting a first subset of measurement transmission recordings. It is further possible, when detecting the first subset of measurement transmission recordings, to detect one or the first measurement transmission recording also as the first reference transmission recording.

After detecting a reference transmission recording of the test object, now a further subset of measurement transmission recordings is detected with a further measurement angle step width which is offset from or different from the preceding step width, wherein the further measurement angle step width is between 5° and 30° (or between 10° and 20°. Thereupon, a further or a further plurality of reference transmission recordings is detected at the reference angle position or the plurality of reference angle positions in order to acquire further reference information at the further reference detection time. The above steps of detecting a further subset of measurement transmission recordings and of further reference transmission recordings are now executed repeatedly until the complete number of measurement transmission recordings or the complete transmission dataset (projection dataset) and the needed reference information are at hand.

With respect to determining the reference angle position or the plurality of reference angle positions (for the detection of reference transmission recordings of the test object at the reference times) it is noted that the same are predetermined based on a geometrical shape or an aspect ratio of the test object to acquire reference information of the test object at reference angle positions which are as meaningful as possible. Here, the reference angle positions are if possible selected in order to acquire accentuated, clear exterior structures and a resulting image contrast which is as high as possible (in the reference transmission recordings), resulting transmission lengths which are as short as possible and/or identifiable interior structures from the reference transmission recordings in order to be able to derive information as exact as possible with respect to the interference on the measurement transmission recordings at the respective reference times.

Based on the respective reference transmission recordings or the plurality of the reference transmission recordings at the respective reference time, the processing and control means 170 may now determine reference information based on the reference transmission recordings, wherein the reference information represents the interference on the measurement transmission recording each at least at the different reference times (at least approximately). This is represented by step 350 in FIG. 3. Thereupon, the CT recording may be reconstructed based on the transmission dataset (as a combination of the different subsets of measurement transmission recordings of the test object) and the reference information in order to acquire a DC-recording of the test object 120 which is as interference-compensated as possible as it is represented in steps 360 and 370 in FIG. 3.

With regard to the different reference transmission recordings at different reference times it has to be noted that without a geometrical change of the image or other interferences apart from image noise basically identical reference transmission recordings result for example between subsequent reference times or a sequence of several reference times. On the other hand, changes in image geometry and other interferences with respect to the measurement transmission recordings may be detected using image processing methods, for example using a cross-correlation calculation or a least-squares calculation based on the reference transmission recordings or based on any other possible image processing methods. In this respect, the currently recorded reference transmission recording is related to the last recorded, first recorded or any other reference transmission recording at the same axial position (reference angle position). This may likewise be applied to the determination of a plurality of reference transmission recordings.

Changes of the image which exceed image noise and may be attributed to changes in image geometry or other interferences with respect to the detected measurement transmission recordings may thus be detected in a “time-dependent way”. Depending on the number of recorded reference transmission recordings (supporting points or reference projections) a high temporal scanning or sampling and along with it a detection of temporally high-frequency (or quickly changing) interferences may be acquired.

In the following, with reference to FIG. 3, a further embodiment of a method for data determination is represented for an interference-reduced computer tomography recording of a test object. It is assumed here that the detection of the transmission dataset is based on k transmission recordings, i.e. on an overall number of k angle steps.

First, one or several meaningful reference angle positions are defined or selected depending on the respective test object. These defined reference angle positions ought to enable to generate the different reference transmission recordings or the resulting reference information at different reference times, wherein the information may be referenced mutually in a way which is as simple and defined as possible, in order to be able to simplify an effective comparison of associated reference transmission recordings by means of image processing methods or make the same more effective and to thus be able to determine possible geometrical changes of the image and other interferences more accurately.

Thereupon, data recording in the form of detecting measurement transmission recordings and reference transmission recordings of the test object 120 is started. For example, data recording may be started at a reference position (step 310), so that for example the first determined transmission recording may (also) be used as a reference transmission recording.

When determining a (first) subset of measurement transmission recordings at m measurement angle positions with m<k, m measurement transmission recordings of the test object are detected (step 210 of FIG. 3). If now the first measurement angle position corresponds to a (first) reference angle position, now the first measurement transmission recording may additionally also be used as a reference transmission recording.

Thereupon, now a (further) reference transmission recording of the test object 120 is executed at the reference angle position. Thus, the (i+1)th reference transmission recording is recorded at the time t+ix (step 220 of FIG. 3).

Here, for example by an image processing operation or image comparison to a preceding reference transmission recording information (reference information) on interferences may be derived using these reference transmission recordings between the two reference times at which the different reference transmission recordings were determined. If for example no interferences occurred or could be determined, these reference transmission recordings differ at the same angle positions at different (e.g. subsequent) reference times only with respect to a noise portion in the image. If, however, interferences exist in the test interval, now further reference information with respect to interferences, like e.g. all measurement transmission recordings recorded in time between the reference transmission recordings may be derived e.g. by an interpolation (see step 350 of FIG. 3). As now interference information or corresponding correction information exists the reconstruction of measurement transmission recordings which were recorded in time between t and t+x (see step 360 of FIG. 3) may now be started directly.

The determination of the reference information (step 350 of FIG. 3) may now for example be divided into the following steps or substeps. Based on reference transmission recordings ((i-th) and (i+1)th reference transmission recording) acquired at the different reference times (e.g. between the reference time t and t+x (x being the time interval between two reference times)) first of all the image shift or geometry change may be determined by the comparison of the reference transmission recordings i and i+1 as a function of time t (step 320 of FIG. 3). Thereupon, the offset or shifting of the position of the optical focal spot at times t and t+x or for the period of time between t and t+x may be calculated (by means of a mathematical interpolation) (step 330 in FIG. 3). Thereupon, the relative position of the optical focal spot may be determined for every measurement transmission recording (step 340 of FIG. 3), and be considered in the reconstruction of measurement transmission recordings recorded in time between t and t+x (step 360 in FIG. 3), in order to acquire interference-reduced or interference-compensated subsets of measurement transmission recordings. A combination of all reconstructed subsets of measurement transmission recordings leads to the reconstructed computer tomography recording (step 370 of FIG. 3).

The above illustrated proceeding for detecting a sequence of different subsets of measurement transmission recordings of the test object 120 at predefined measurement angle positions and the repeated detection of a reference transmission recording (or a plurality of reference transmission recordings) of the test object 120 at different reference times each temporally between two detection processes may be repeated for different subsets of the measurement transmission recordings until the complete transmission dataset with all needed or scheduled k measurement transmission recordings has been acquired (step 370).

It has to be noted with respect to the inventive operation that the number m of measurement transmission recordings to be recorded between two reference times for recording one or several reference transmission recordings, i.e. the sampling frequency of the measurement transmission recordings, does not have to be constant over the duration of the measurement. For example, the number m of measurement transmission recordings per subset may be increased with an increasing measurement duration or be adapted dynamically during runtime using the results of the comparison of preceding reference transmission recordings. In this context it is further noted that recording a further subset of measurement transmission recordings of the test object 120 may already be started before the process of deriving reference information with respect to interferences has been completed.

Further, the number of detection operations for the reference transmission recordings at different reference times (reference time intervals) indicates a measure for the temporal sampling of interferences or the change of the image geometry. The sequence of detecting or determining the actual measurement transmission recording may basically be executed randomly.

For example, recording the measurement transmission recordings in case of n supporting points (i.e. n pieces of reference information based on the reference transmission recordings) may be divided into n-1 equal parts so that the temporal scan of the supporting points is executed distributed as evenly as possible across the dataset or the measurement time. In the present method for data determination, thus the test object is its own reference object.

The above method 200, 300 for data determination for a computer tomography recording is in particular suitable for a compensation of effects of focal spot movements or focal spot migrations during the detection of measurement transmission recordings of the test object 120. If now, for example, the CT arrangement is arranged in a so-called parallel beam geometry, an instability of the position of the x-ray source, i.e. the focal spot, leads to a translation of the image of the test object 120. Using image processing methods, this translation of the image of the test object 120 may be detected from stationary object features. In this respect, the above-mentioned image processing methods are applied to the detected reference transmission recordings (according to the above presented operation).

With a design of the CT arrangement with a fan or cone beam geometry, a movement of the optical focal spot only approximately leads to a translation of the image of the test object, as the test object 120 is transmitted or penetrated from a different perspective. The approximation is here the better the smaller the perspective distortion by the movement of the optical focal spot or the smaller the open angle defined by the focus/detector distance (FDA) and the detector width or detector height is. This angle decreases with an increasing FDA.

From shifting or an offset of the object image the actual position may not be concluded but the movement of the optical focal spot. In embodiments of the present invention for data determination for an interference-reduced computer tomography recording no special calibration bodies are needed.

The image sequence, i.e. the reference transmission recordings, for determining the image shifts resulting from the focal spot movements is generated, according to embodiments, by approaching the same recording geometry several times, i.e. at different reference times the same recording geometry is each generated with one or several reference transmission recordings.

From this image sequence of the reference transmission recordings, for example, the relative positions of the optical focal spot may be determined at discrete times t+ix. Here, t represents the first time of a reference time, while x represents the time duration between two reference times. These time-discrete points now represent the supporting points for determining a continuous function (correction function) with respect to place and time, which approximately describes the relative position of the optical focal spot at any time of the measurement time periods between the reference times. Thus, using this correction function, the relative position of the optical focal spot may be derived for any measurement transmission recording on the basis of an interpolation. The quality of the derivation may here be improved by a finite increase of the temporal sampling frequency of the reference transmission recordings.

According to the invention, thus a correction function (e.g. continuous with respect to place and time) is formed by means of an interpolation of reference information serving as supporting points, wherein the correction function represents a temporal course or a temporal dependency of the interference on the measurement transmission recordings of the transmission dataset. The interference or interference variable here is the change of the image geometry of the CT system due to a focal spot migration of the x-ray source of the CT system.

If now the reconstruction operation of the measurement transmission recordings recorded in time between t and t +x represented in step 360 of FIG. 3 is executed based on a reconstruction algorithm, the correction function describing the relative focal spot position at any time within the measurement time period may be provided to the reconstruction algorithm as additional information relating to the measurement transmission recordings. Thus, the reconstruction operation may be executed using the reconstruction algorithm and considering the correction function which reflects a temporal change of the image geometry of the CT system, in order to acquire the interference-compensated computer tomography recording based on a combination of all reconstructed and interference-compensated subsets of the measurement transmission recordings. Thus, the low pass character of a moving focal spot may be compensated in the reconstruction of the measurement transmission recordings. This leads to an increased resolution or detectability of details in the CT recording by the measurement system.

A combination of all reconstructed subsets of measurement transmission recordings thus leads to the reconstructed computer tomography recording. For the case that a reconstruction algorithm is used which may not consider any change of the image geometry over measurement time, according to a further embodiment, an interference compensation in a computer tomography recording consists in acquiring a modified transmission dataset by digitally shifting the interference-loaded measurement transmission recordings in an opposite way to the detected change of the image geometry based on the correction data or the correction function, wherein then the computer tomography recording is reconstructed based on the modified transmission dataset. It is thus possible to carry out the modified transmission dataset by digitally shifting the measurement transmission recordings opposite to the detected shift of the reference transmission recordings. This way, the influence of the movement of the focal spot may be approximately inverted already on the level of the detected data of the measurement transmission recordings. The reconstruction algorithm may then take the optical focal spot to be stationary. Based on the above-discussed approximation, however, in case of a fan or cone beam geometry, the compensation during reconstruction is regarded to be effective.

In the following, resulting effects (actions and/or advantages) of embodiments of the present invention are illustrated. The embodiments of the present invention form the basis for the detection and compensation of time-dependent interferences in a computer tomography recording in a computer tomography system. Geometrical and other (e.g. thermal) influential factors may be reliably detected and quantified according to the inventive concept for data determination for a computer tomography recording of a test object in a CT system and in particular the computer tomography system.

With embodiments of the present invention, different subsets of measurement transmission recordings and reference transmission recordings are detected alternatingly, wherein reference transmission recordings are recorded several times at one or several reference positions, i.e. one after the other at the respective reference times. By this, an early detection and consideration of interferences may be executed in image data recording. This leads to an improvement of image quality by a compensation of these interferences detected early and thus leads at the same time to improvements of test and analysis results due to the improved image quality. Further, the inventive concept may be operated saving time, as no additional complete fast scan of the test object is needed. Further, very good compensation results may be acquired by the temporal correlation between the respective reference transmission recordings and the associated measurement transmission recordings and by the fact that, when recording a reference transmission recording or a small number of reference transmission recordings, virtually no focal spot movement takes place as only one single or a small number of reference transmission recordings are involved. Thus, an improved image quality of the resulting 2D/3D computer tomography recording and further more precise and robust measurement analysis results may be acquired.

Further, no iterative sequences are needed, but a strong parallelization may occur in processing the measurement transmission recordings based on the associated reference transmission recordings. In particular, a (immediate) reconstruction of a subset of the measurement transmission recordings is possible after completing the subsequent reference transmission recording and determining the reference information (only a minimum delay may occur at most by the detection time each of the m measurement transmission recordings plus the duration of step 350). Further, an optimally utilized active image area of the x-ray detector 130 results, as no reference objects are needed or are present which have to be analyzed which at least partially shadow the image area and are not available for an image reproduction. As, according to embodiments of the present invention, no reference object has to be used, further time savings result for the complete operation, as its position or size or nature does not have to be adapted to the geometric magnification or to the radiation hardness of the x-radiation used.

Further, there is virtually no (additional) requirement concerning the manipulation system, i.e. concerning the processing and control means 170 and the associated actuators (not illustrated in FIG. 1), as no shifting of the components occurs for the compensation of the movement of the optical focal spot already before recording the measurement transmission recordings.

According to embodiments, the method for data determination has such an effect on data acquisition that data acquisition not only needs exactly one rotation (one full rotation) of the test object but the angle positions may be approached in a changed order in the form of n rotations or any other sampling sequences. By recording n′≧n reference transmission recordings, a very high temporal sampling results for determining the focal spot position. Depending on the measure of the selected value m (for the number of measurement transmission recordings per subset) this operation has an increased time expenditure as compared to a pure measurement data acquisition which substantially depends on the speed of the axis of rotation. By the increased temporal sampling of the reference transmission recordings, however, also high-frequency, i.e. very quickly changing interference factors may be detected and compensated, like e.g. the focal spot movements of the x-ray source 110.

Thus, an increased precision of the compensation of the focal spot movement may be acquired. Apart from the angular dependency of the determinability of the focal spot position also the temporal component is considered, so that depending on the sampling speed also high-frequency, i.e. relatively quickly changing, focal spot movements may be detected and compensated. This directly leads to a reduced blur of the resulting computer tomography recording, i.e. to an improved bit quality in the reconstruction data. On the basis of the improved image data, more precise and robust analysis and measurement results may be acquired according to the respective test object. In particular, the above-described improvements of image quality may also be acquired without the use of reference bodies. Thus, the maximum image size may be used for imaging the test object, whereby a maximum spatial resolution and detail recognizability may be realized.

Apart from the detection and compensation of a focal spot movement, further also a change of magnification in the image may be detected and compensated as well as a movement of the object under boundary conditions.

The inventive concept for data determination for an interference-reduced computer tomography recording of a test object may basically be used with all computer tomography systems and in particular with computer tomography systems in which high spatial resolutions (≦5 μm) be acquired. The processing and control means 170 may now be implemented in order not to discard the measurement transmission recordings or the resulting complete transmission dataset (i.e. the original image information) after a reconstruction of the transmission dataset has been executed using the reference information. Thus, it may be traced transparently to what extent a compensation of a focal spot movement took place, wherein the reconstruction results may be compared with and without a compensation based on the reference information.

In computer tomography, the embodiments of the present invention may be used in particular for the compensation of horizontal and vertical focal spot migrations for the compensation of magnification changes and for a compensation of fluctuations in radiation intensity or for a detection of changes in the radiation spectrum. In this respect, no additional requirements to existing CT systems are needed as the same exist anyway for executing a computer tomography recording.

In case of radioscopy systems, embodiments of the present invention may be used by recording several transmission recordings with a correspondingly shorter exposure instead of individual recordings and subsequently summing them up. In this case, no object axis of rotation is needed. Thus, embodiments of the present invention may also be used with x-ray systems which operate with low photon fluxes.

It is further to be noted that the inventive concept is basically not limited to the application in x-ray technology but is possible for all imaging methods in which time-dependent interferences exist and ought to be compensated if possible.

Although some aspects were described in connection with an image processing device it is obvious that those aspects also represent a description of the corresponding method for determining calibration data for a computer tomography system, so that a block or a member of a device may also be regarded as a corresponding method step or as a feature of a method step. Analog to this, aspects which were described in combination with or as a method step also represent a description of a corresponding block or detail or feature of a corresponding device. Some or all method steps may also be executed by a hardware apparatus (or using a hardware apparatus), like e.g. a microprocessor, a programmable computer or an electronic circuit. In some embodiments, some or several of the important method steps may be executed by such an apparatus.

Depending on the determined implementation expenditure, embodiments of the invention may be implemented in hardware or in software, like e.g. in Volex software. The implementation may be executed using a digital storage medium, for example a blue-ray disc, a CD, an ROM, a PROM, an EPROM, an EEPROM or a flash memory, a hard disc or any other magnetical or optical memory on which electronically readable control signals are stored which cooperate with a programmable computer system or may cooperate with the same such that the respective method is executed. Thus, the digital storage medium may be computer-readable.

Some embodiments according to the invention thus include a data carrier which comprises electronically readable control signals which are able to cooperate with a programmable computer system such that one of the methods described herein is executed.

In general, embodiments of the present invention may be implemented as a computer program product having a program code, wherein the program code is effective in order to execute one of the methods when the computer program product is executed on a computer. The program code may for example also be stored on a machine-readable carrier. Other embodiments include the computer program for executing one of the methods described herein, wherein the computer program is stored on a machine-readable carrier.

In other words, an embodiment of the inventive method is thus a computer program comprising a program code for executing one of the methods described herein when the computer program is executed on a computer.

A further embodiment of the inventive method thus is a data carrier (or a digital storage medium or a computer-readable medium) on which the computer program for executing one of the methods described herein is recorded. A further embodiment of the inventive method is thus a data stream or sequence of signals representing the computer program for executing one of the methods described herein. The data stream or the sequence of signals may for example be configured in order to be transferred via a data communication connection, for example via the internet.

A further embodiment includes a processing means, for example a computer or a programmable logics device which is configured or adapted in order to execute one of the methods described herein. A further embodiment includes a computer on which the computer program for executing one of the methods described herein is installed.

A further embodiment according to the invention includes a device or a system which is implemented to transmit a computer program for executing at least one of the methods described herein to a receiver. The transmission may take place for example electronically or optically. The receiver may for example be a computer, a mobile device, a memory device or a similar device. The device or the system may for example include a file server for transmitting the computer program to the receiver.

In some embodiments, a programmable logic device (for example a field-programmable gate array, an FPGA) may be used to execute some or all functionalities of the methods described herein. In some embodiments, a field programmable gate array may cooperate with a microprocessor in order to execute one of the methods described herein. In general, in some embodiments the methods are executed by any hardware device. The same may be a universally useable hardware like a computer processor (CPU) or hardware which is specific for the method, like for example an ASIC.

The above-discussed embodiments merely represent an illustration of the principles of the present invention. It is obvious that modifications and variations of the arrangements and details described herein are clear for other persons skilled in the art. The invention is thus only restricted by the scope of the pending patent claims and not by the specific details presented herein by the description and the specification of the embodiments.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A method for data determination for a computer tomography recording of a test object, comprising:
detecting a sequence of different subsets of measurement transmission recordings of the test object at predetermined, different measurement angle positions to acquire an overall number of measurement transmission recordings based on the different subsets of measurement transmission recordings; and
repeatedly detecting a reference transmission recording of the test object at different reference times at a reference angle position, wherein one reference time each of the different reference times is temporally between two detection processes for the different subsets of measurement transmission recordings.

2. The method according to claim 1, further comprising:
determining reference information based on the reference transmission recordings, wherein the reference information indicates the interference on the measurement transmission recordings each at the different reference times.

3. The method according to claim 2, further comprising:
Reconstructing the computer tomography recording based on the overall number of measurement transmission recordings and the reference information in order to acquire an interference-compensated computer tomography recording of the test object.

4. The method according to claim 1, wherein in the step of detecting a reference transmission recording at a reference time one further or a plurality of further reference transmission recordings of the test object are detected at different, predetermined reference angle positions in order to determine the reference information.

5. The method according to claim 2, wherein in step of determining the reference information an image processing operation is executed on the reference transmission recordings.

6. The method according to claim 5, wherein the image processing operation is executed using a cross-correlation calculation or a least-squares calculation based on the reference transmission recordings.

7. The method according to claim 1, further comprising:
determining a correction function using an interpolation of the reference information serving as supporting points, wherein the correction function reproduces a temporal course of the interference with respect to the measurement transmission recordings.

8. The method according to claim 1, wherein the interference is a change of the image geometry of a computer tomography system due to a focal spot migration of an x-ray source of the computer tomography system.

9. The method according to claim 1, comprising:
determining the reference angle position for the detection process of the reference transmission recordings of the test object based on a geometrical shape or an aspect ratio of the test object in order to acquire, at the determined reference angle position, based on a resulting exterior contour, a resulting image contrast, resulting transmission lengths and/or resulting interior structures, information determinable from the reference transmission recording with regard to the interference on the measurement transmission recordings.

10. The method according to claim 1, comprising:
detecting a first subset of measurement transmission recordings with a measurement step width, wherein the measurement step width lies between 5° and 30°;
detecting the reference transmission recording of the test object at a reference angle position at a reference time in order to acquire the reference information;
detecting a further subset of measurement transmission recordings with a further measurement step width which is different from the measurement step width or comprises measurement angle position offset from the same, wherein the further measurement step width lies between 5° and 30°;
detecting a further reference transmission recording at the reference angle position in order to acquire further reference information with respect to the further reference detection time; and
repeating the above steps of detecting a further subset of measurement transmission recordings and of further reference transmission recordings to acquire the complete number of measurement transmission recordings and the associated reference information.

11. The method according to claim 7, comprising:
executing the reconstruction process using a reconstruction algorithm and considering the correction function which reproduces a temporal change of the image geometry of the computer tomography system in order to acquire in the interference-compensated computer tomography recording.

12. The method according to claim 7, further comprising:
generating a modified transmission dataset based on the overall number of measurement transmission recordings by digitally shifting the measurement transmission recordings comprising interferences opposite to the detected change of the image geometry based on the correction function.

13. The method according to claim 12, comprising:
reconstructing the computer tomography recording based on the modified transmission dataset.

14. A non-transitory computer readable medium including a computer program product comprising a program code for executing the method steps of a method for data determination for a computer tomography recording of a test object, comprising:
detecting a sequence of different subsets of measurement transmission recordings of the test object at predetermined, different measurement angle positions to acquire an overall number of measurement transmission recordings based on the different subsets of measurement transmission recordings; and
repeatedly detecting a reference transmission recording of the test object at different reference times at a reference angle position, wherein one reference time each of the different reference times is temporally between two detection processes for the different subsets of measurement transmission recordings.

15. A computer tomography system for data determination for a computer tomography recording of a test object, comprising:
a computer tomography arrangement for generating transmission recordings of a test object, wherein the computer tomography arrangement and the test object are arranged rotatably relative to each other; and
a device for processing and controlling which is coupled to the computer tomography arrangement and which is further implemented to detect a sequence of different subsets of measurement transmission recordings of the test object at predetermined angle positions in order to acquire, based on the different subsets of measurement transmission recordings, an overall number of measurement transmission recordings to repeatedly detect a reference transmission recording of the test object at different reference times at a reference angle position, wherein one of the different reference times each is temporally between two detection operations for the different subsets of measurement transmission recordings.

16. The computer tomography system according to claim 15, wherein the device for processing and controlling is implemented to determine reference information based on the reference transmission information, wherein the reference information indicates the interference on the measurement transmission recordings at the different reference times each.

17. The computer tomography system according to claim 15, wherein the device for processing and controlling is implemented to reconstruct the computer tomography recording based on the overall number of measurement transmission recordings and the reference information in order to generate an interference-compensated computer tomography recording of the test object.

18. The computer tomography system according to claim 15, wherein the computer tomography arrangement comprises an x-ray reflection source for generating x-rays penetrating the test object, and a detector which is sensitive for x-rays for detecting the transmission recordings of the test object.

19. A device for processing and controlling for a computer tomography system for executing the method for data determination for a computer tomography recording of a test object, comprising:
detecting a sequence of different subsets of measurement transmission recordings of the test object at predetermined, different measurement angle positions to acquire an overall number of measurement transmission recordings based on the different subsets of measurement transmission recordings; and
repeatedly detecting a reference transmission recording of the test object at different reference times at a reference angle position, wherein one reference time each of the different reference times is temporally between two detection processes for the different subsets of measurement transmission recordings.
